(19) United States
(12) Patent Application Publication
(10) Pub. No.: US 2004/0066339 A1
(43) Pub. Date: Apr. 8, 2004

(54) Antenna

(76) Inventors: Jim Lin, Tauyuan City (TW); Fu-An Chu, Tauyuan City (TW); Jacky Chen, Tauyuan City (TW); Mike Lin, Tauyuan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/614,494

(22) Filed: Jul. 7, 2003

(30) Foreign Application Priority Data
Oct. 3, 2002 (TW) 091215715

(51) Int. Cl. H01Q 1/38

(52) U.S. Cl. 343/700 MS

(57) ABSTRACT

A rectangular metal slice is cut into antenna sheet material. The antenna sheet material is further folded up to form the antenna. The antenna sheet material includes a radiating plate, a feeding plate, and a ground plate. The length of the radiating plate is approximate quarter wavelength corresponding to the operating frequency. The main feature of the antenna, according to the invention, is that the feeding plate and the ground plate extend in the same direction, thereby reducing the scale of the antenna.

This application claims the benefit of Taiwan application Serial No. 91215715, filed Oct. 3, 2002.

### BACKGROUND OF THE INVENTION

1. Field of the Invention

The invention relates in general to an antenna, and more particularly to an antenna whose components can be manufactured to a unity.

2. Description of the Related Art

As the communication industry rapidly develops, various wireless products are being produced, with the currently well-known wireless local area network as an example. Its related products have high value and create much interest in the market. In wireless systems, antennas are very important components. With respect to the design of antennas, the miniaturization of the antenna is taken into account in accordance with design objectives to make devices thin and small in addition to enhancing performance.

In practical applications, antenna structure is largely varied depending on the design requirements, for example a monopole antenna or a patch antenna. There are a number of antenna architectures that can be used in wireless local area networks. One of which is made by cutting a metal slice into an antenna sheet material with a suitable shape and then folding the antenna sheet material to form an antenna structure. Referring to FIG. 1A, a schematic view of a typical antenna sheet material is shown. A rectangular metal slice with an area of A*B is cut into the antenna sheet material. The antenna sheet material includes a radiating plate 110, a feeding plate 130, and a ground plate 150, which are manufactured to a unity. Subsequently, the feeding plate 130 and the ground plate 150 of the antenna sheet material are folded up to form an antenna 100 as shown in FIG. 1B. The length of the radiating plate 110 is equal to the length A of the antenna sheet material minus the height H of the feeding plate 130.

The shape of the antenna 100 is like an inverted character F. The length of the radiating plate 110 is approximate quarter wavelength corresponding to the operating frequency. That is, the resonance wave in the radiating plate 110 has a wavelength one fourth of that corresponding to the operating frequency. The feeding plate 130 coupled to the radiating plate 110 is provided for transmitting radio frequency signals. The ground plate 150 is used as a ground terminal of the antenna 100.

A metal slice is cut into a sheet material, and the sheet material is then folded up to form an antenna. Therefore, the larger the accessible area of the metal slice for manufacturing the antenna is, the more efficiently the material will be used and the more the cost will be lowered. A new configuration of the antenna sheet material for fabricating the antenna is required in order to increase the accessible area of the metal slice, and lower the production cost, thereby improving the competitive force of the antenna products.

### SUMMARY OF THE INVENTION

It is therefore an object of the invention to provide an antenna whose scale can be decreased thereby reducing the fabrication cost.

The invention achieves the above-identified objects by providing an antenna as described below.

A rectangular metal slice is cut into an antenna sheet material, and the antenna sheet material is further folded up to form the antenna. The antenna sheet material includes a radiating plate, a feeding plate, and a ground plate. The length of the radiating plate is approximate quarter wavelength corresponding to the operating frequency. A feature of the invention is that the feeding plate and the ground plate extend in the same direction, thereby decreasing the required material of the antenna.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a schematic view of a typical antenna sheet material;

FIG. 1B (Prior Art) is a schematic view illustrating the formation of the antenna by folding up the antenna sheet material in FIG. 1A;

FIG. 2A is a schematic view of antenna sheet material according to a preferred embodiment of the invention;

FIG. 2B is a schematic view illustrating the formation of the antenna by folding up the antenna sheet material in FIG. 2A;

FIG. 3A is a schematic view of antenna sheet material according to another preferred embodiment of the invention; and

FIG. 3B is a schematic view illustrating the formation of the antenna by folding up the antenna sheet material in FIG. 3A.

### DETAILED DESCRIPTION OF THE INVENTION

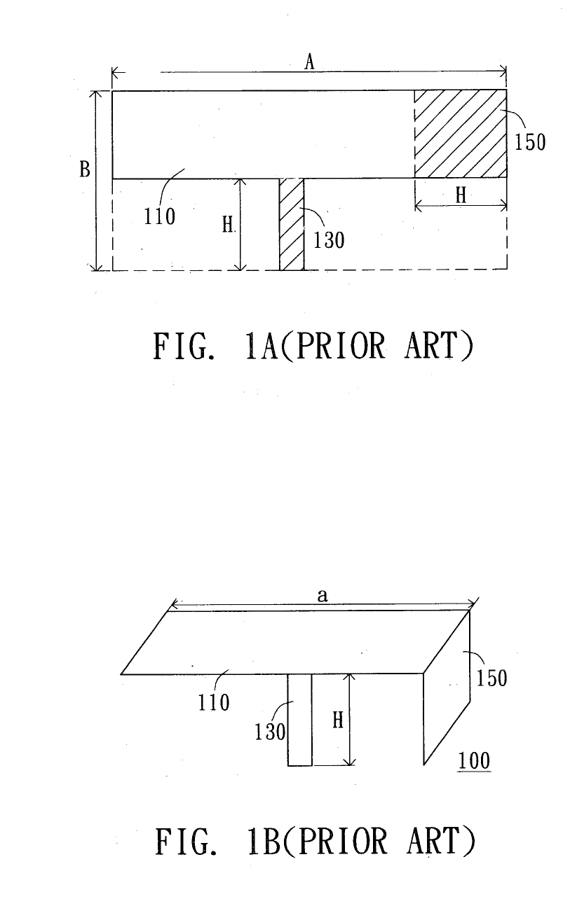

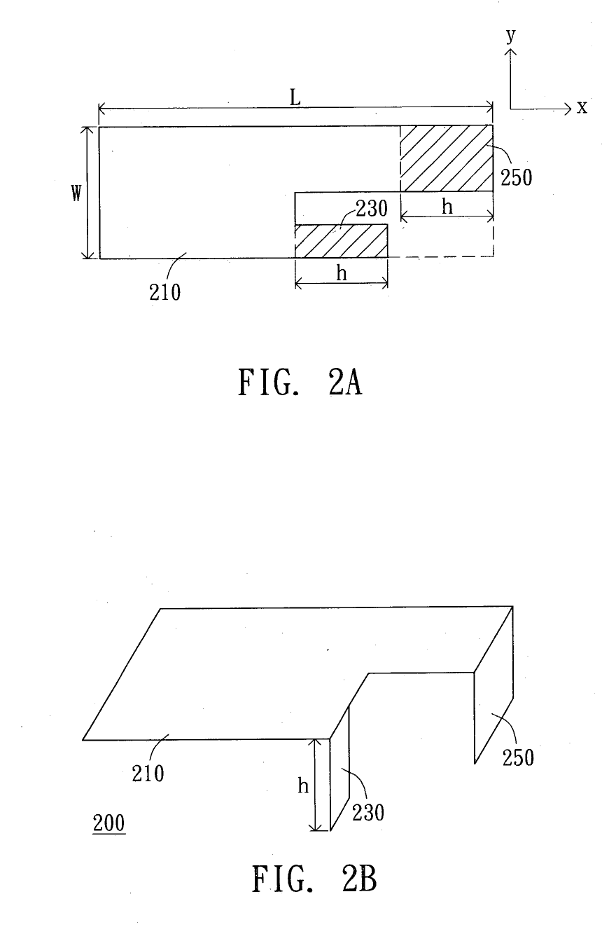

Referring to FIG. 2A, a schematic view of antenna sheet material according to a preferred embodiment of the invention is shown. The antenna sheet material can be folded into a three-dimensional antenna structure. The antenna sheet material also includes a radiating plate 210, a feeding plate 230, and a ground plate 250. Referring to FIG. 1A along with FIG. 2A, the feeding plate 230 and the ground plate 250 extend in the same direction as the x direction shown in FIG. 2A, which is substantially different from the prior art. From another point of view, the feeding plate 230 and the ground plate 250 are both rectangular, and their longer sides are both extended in the x direction. Since the longer sides of the feeding plate 230 and the ground plate 250 are parallel, the scale of the rectangular metal slice needed to form the sheet material can be reduced, for example, a typical area A*B reduced to an area L*W as shown in FIG. 2A. By using this approach to design the antenna sheet material, the rectangular metal slice used to make the antenna sheet material can have a shorter length and a shorter width than is typically used. In other words, the length L of the antenna 200 according to the invention will be smaller than the length A of the typical antenna in case they have the same operating frequency. Similarly, the length of the radiating plate 210 is approximate quarter wavelength corresponding to the operating frequency. This is more obvious in the reduction of the width than the length of the antenna in the invention compared with the typical one, as illustrated in FIG. 2A. The feeding plate 230 and the ground plate 250 are folded to the three-dimensional antenna 200, and the height h of the feeding plate 230 is the same as that of the ground plate 250 as shown in FIG. 2B.

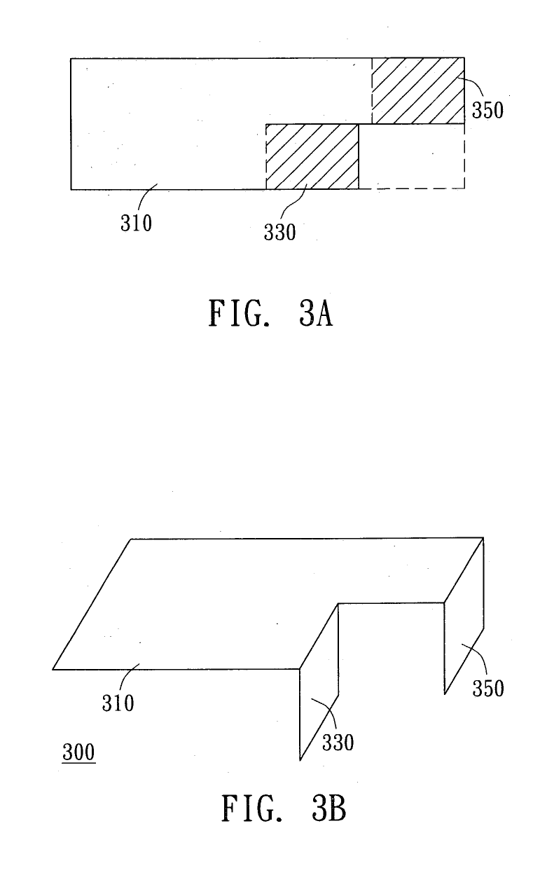

According to the same above-mentioned design concept, the appearance of the antenna sheet material in FIG. 2A can be changed slightly to form another preferred embodiment as shown in FIG. 3A. The antenna sheet material includes a radiating plate 310, a feeding plate 330, and a ground plate 350. The feeding plate 330 and the ground plate 350, extending in the same direction, are folded to form the antenna 300 as shown in FIG. 3B.

The antenna according to the invention has the distinguishing features of small volume and low cost. This design concept can also be applied to other wireless products, for example the mobile phone, in addition to the wireless local area network (WLAN). In fact, its applications can be extensive.

The antenna according to the invention described above includes the following advantages:

1. The volume of materials required for manufacturing the antenna can be reduced with a subsequent reduction in production costs. Thus the competitive force of the products can be enhanced.

2. The scale of the antenna can be reduced to meet the design requirement that devices be made thin and small.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An antenna, an antenna sheet material folded up to form an antenna, the antenna sheet material comprising a radiating plate, a feeding plate, and a ground plate;
wherein the radiating plate, the feeding plate, and the ground plate are manufactured to a unity, and the feeding plate and the ground plate extend in the same direction.

2. The method according to claim 1, wherein the length of the radiating plate is approximate quarter wavelength corresponding to the operating frequency of the antenna.

3. An antenna, an antenna sheet material folded up to form an antenna, the antenna sheet material comprising:
a radiating plate,
a feeding plate, and
a ground plate;
wherein the longer side of the feeding plate is parallel to the longer side of the ground plate.
